(19) United States
(12) Patent Application Publication
(10) Pub. No.: US 2015/0176993 A1
(43) Pub. Date: Jun. 25, 2015

(54) MEMS SENSOR MODULE AND MEMS SENSOR PACKAGE MODULE

(71) Applicant: SAMSUNG ELECTRO-MECHANICS CO., LTD., Gyeonggi-Do (KR)

(72) Inventors: Won Kyu JEUNG, Gyeonggi-Do (KR); Jung Won LEE, Gyeonggi-Do (KR); Jong Hyeong SONG, Gyeonngi-Do (KR)

(73) Assignee: SAMSUNG ELECTRO-MECHANICS CO., LTD., Gyeonggi-Do (KR)

(21) Appl. No.: 14/290,337

(22) Filed: May 29, 2014

(30) Foreign Application Priority Data
Dec. 23, 2013 (KR) 10-2013-0161560

(51) Int. Cl. G01C 19/5705; G01P 15/09

(52) U.S. Cl. CPC G01C 19/5705; G01P 15/0922

(57) ABSTRACT

Embodiments of the invention provide a micro electro mechanical system (MEMS) sensor module, including a sensor, a substrate connected to the sensor, and an external board connected to the substrate by a conductive connector. The substrate is provided with a cavity so as to be opposite to the sensor.

### CROSS REFERENCE TO RELATED APPLICATION

This application claims the benefit of and priority under 35 U.S.C. §119 to Korean Patent Application No. KR 10-2013-0161560, entitled “MEMS SENSOR MODULE AND MEMS SENSOR PACKAGE MODULE,” filed on Dec. 23, 2013, which is hereby incorporated by reference in its entirety into this application.

### BACKGROUND

1. Field of the Invention

The present invention to a micro electro mechanical system (MEMS) sensor module and a MEMS sensor package module.

2. Description of the Related Art

Generally, a MEMS sensor, for example, a multi-axis acceleration sensor or a multi-axis angular velocity sensor is used in various applications, for example, for a vehicle, an airplane, a mobile communication terminal, a toy, as non-limiting examples. The MEMS sensor has been developed for high performance and miniaturization in order to detect fine acceleration.

A device including the MEMS sensor is very sensitive to a change in external stress.

Recently, the MEMS sensor has been used increasingly in a mobile device, for example, a mobile phone. The reason is that MEMS technology is capable of fabricating a device requiring various applications, various sensors, and actuators in a miniaturized package.

A device including the MEMS sensor has a structure, which sensitively reacts to a change in various stresses or external forces in addition to a change in a physical amount.

Improvement in driving characteristics of a driving body has become a major factor for improving sensitivity.

Thus, since the MEMS sensor, as described, for example, in U.S. Patent Publication No. 2009/0232918, forms a cavity by a cap adjusting a size of a mass body or covering a sensor part in order to form the cavity, a degree of freedom thereof is limited and it is difficult to implement thinness.

### SUMMARY

Accordingly, embodiments of the invention have been made in an effort to provide a thin MEMS sensor module, in which a separate sensor part cap is not coupled to a sensor part by forming a cavity in a substrate having the sensor part coupled thereto, maximizing driving performance by optimally designing a depth of the cavity in the substrate.

Further, embodiments of the present invention have been made in an effort to provide a MEMS sensor package module including a MEMS sensor having improved driving characteristics as a design for a depth of a cavity, in which a first cavity opposite to the sensor part and an optimal design for the depth of the cavity is possible through an extending groove part of a width side by a second cavity extended to a direction perpendicular to a direction in which the first cavity is formed.

According to an embodiment of the invention, there is provided a MEMS sensor module, including a sensor, a substrate connected to the sensor, and an external board connected to the substrate by a conductive connector. The substrate is provided with a cavity so as to be opposite to the sensor.

According to an embodiment, the sensing part includes a mass body, a flexible substrate to which the mass body is displaceably coupled and on which a driver and a piezoelectric sensor are selectively formed, and a support having the flexible substrate coupled thereto and configured to support the mass body in a state in which it floats. The cavity of the substrate is formed so as to be opposite to the mass body.

According to another embodiment of the invention, there is provided a MEMS sensor package module, including a sensor, an upper cover coupled to one side of the sensor, a substrate coupled to the other side of the sensor, an application specific integrated circuit (ASIC) coupled to the upper cover, an external board connected to the substrate by a conductive connector, and a mold configured to package the sensor coupled to the substrate. The substrate is provided with a cavity so as to be opposite to the sensor.

According to an embodiment, the sensing part includes a mass body, a flexible substrate to which the mass body is displaceably coupled and on which a driver and a piezoelectric sensor are selectively formed, and a support having the flexible substrate coupled thereto and configured to support the mass body in a state in which it floats. The cavity of the substrate is formed so as to be opposite to the mass body.

According to an embodiment, the cavity is formed to be extended to a stack direction in which the sensor is coupled to the substrate.

According to an embodiment, the ASIC is coupled to the substrate by wire bonding.

According to another embodiment of the invention, there is provided a MEMS sensor package module, including a sensor, an upper cover coupled to one side of the sensor, a substrate coupled to the other side of the sensor, an ASIC coupled to the upper cover, an external board connected to the substrate by a conductive connector, and a mold configured to package the sensor coupled to the substrate. The substrate is provided with a first cavity in a stack direction in which the sensor is coupled to the substrate, and a second cavity extended in a direction perpendicular to a direction in which the first cavity is formed.

According to an embodiment, the sensor includes a mass body, a flexible substrate to which the mass body is displaceably coupled and on which a driver and a piezoelectric sensor are selectively formed, and a support having the flexible substrate coupled thereto and configured to support the mass body in a state in which it floats. The first cavity of the substrate is formed so as to be opposite to the mass body. The second cavity thereof is extended to the direction perpendicular to the direction in which the first cavity is formed.

According to an embodiment, the ASIC is coupled to the substrate by wire bonding.

According to an embodiment, the conductive connector is a solder.

Various objects, advantages and features of the invention will become apparent from the following description of embodiments with reference to the accompanying drawings.

### BRIEF DESCRIPTION OF DRAWINGS:

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a cross-sectional view schematically showing a configuration of a MEMS sensor module according to an embodiment of the invention.

FIG. 2 is a cross-sectional view schematically showing a configuration of a MEMS sensor package module according to another embodiment of the invention.

FIG. 3 is a cross-sectional view schematically showing a configuration of a MEMS sensor package module according to another embodiment of the invention.

### DETAILED DESCRIPTION:

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

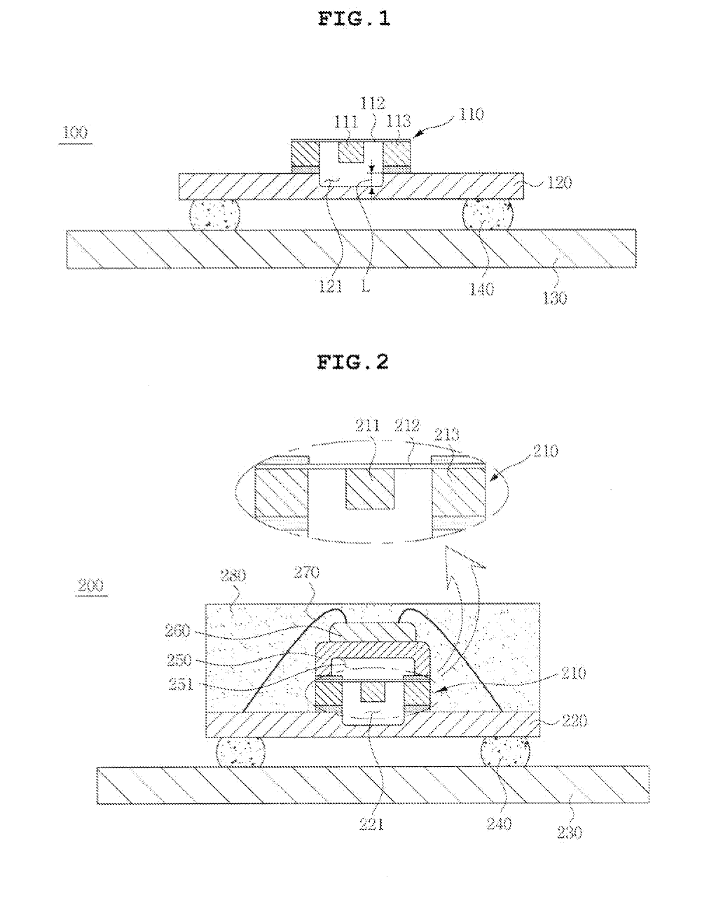

FIG. 1 is a cross-sectional view schematically showing a configuration of a MEMS sensor module according to an embodiment of the invention. As shown in FIG. 1, the MEMS sensor module 100, according to various embodiments, includes a sensor 110, a substrate 120, an external board 130, and a conductive connector 140. According to at least one embodiment, the substrate 120 is provided with a cavity 121 so as to be opposite to the sensor 110.

According to at least one embodiment, the sensor 110 includes a sensing unit or sensor configured to measure a change in a physical amount. The sensor 110 includes a mass body 111 that detects the physical amount by measuring a displacement of the mass body. Embodiments of the invention further provide a method for detecting the physical amount including, for example, a capacitive-type measurement of a change in capacitance for the displacement of the mass body, a piezoelectric-type measurement of a change in a charge amount generated from a piezoelectric material, or a piezoresistance-type measurement of a change in resistance of a piezoresistor.

According to at least one embodiment, the sensor 110 further includes a flexible beam 112 and a support 113, as shown, for example, in FIG. 1.

Additionally, the mass body 111, which is displaced by an inertial force, a Coriolis force, or an external force, as non-limiting examples, is displaceably connected to the flexible beam 112.

Additionally, in order to implement an angular velocity sensor, the flexible beam 112, according to an embodiment, includes a driving unit or driver and a sensing unit or sensor formed on one surface thereof. In order to implement an acceleration sensor, the flexible beam 112, according to an embodiment, includes a piezoelectric resistance element formed on one surface thereof. In addition, the flexible beam 112, according to an embodiment, includes the mass body 111 coupled to the other surface thereof. The support 113 is coupled to the other surface of the flexible beam 112, so that the mass body 111 floats, and supports the flexible beam 112.

Additionally, according to an embodiment, the sensor 110 is coupled to the substrate 120. The substrate 120 is provided with the cavity 121 so as to be opposite to the mass body 111 of the sensor 110, as described above.

According to an embodiment, the substrate 120 is electrically connected to the external board 130 by the conductive connector 140. According to an embodiment, the conductive connector 140 is made of a solder.

As described above, driving performance of the sensor 110 can be maximized by using an optimal structure of the cavity 121 formed in the substrate 120.

More specifically, when a depth of the cavity 121 becomes thin, damping largely acts between the mass body 111, which is the driving body, and the flexible beam 112, thereby decreasing performance of the sensor 110.

In contrast, when the depth of the cavity 121 becomes deep, the flexible beam 112 is formed to have an enlarged thickness, such that a thickness of the module is also thick.

In order to implement an optimal design through the embodiments described above, a damping characteristic may be defined as the following Knudsen number Kn. More specifically, when the depth of the cavity 121 is set to have a Knudsen number of 10 or more, an optimal cavity 121 depth can be selected without deteriorating the driving characteristic, using the following equation.

$$Kn = \frac{λ}{L} = \frac{{K}_{B}}{\sqrt{2 π} {σ}^{2} PL}$$

where L is a depth of a cavity, λ is a mean free path, κ_{B} is a Bolzmann constant, T is a temperature, σ is a particle hard shell diameter, and P is a pressure.

As a result, the MEMS sensor module 100 according to an embodiment of the invention, is thinned by forming the cavity 121 in the substrate 120 coupled to the external board 130, improving the driving characteristics of the MEMS sensor module 100 by the optimal design of the cavity 121.

FIG. 2 is a cross-sectional view schematically showing a configuration of a MEMS sensor package module according to another embodiment of the invention. As shown in FIG. 2, the MEMS sensor package module 200, according to various embodiments, includes a sensor 210, a substrate 220, an external board 230, a conductive connector 240, an upper cover 250, an application specific integrated circuit (ASIC) 260, a wire 270, and a mold 280. According to at least one embodiment, the substrate 220 is provided with a cavity 221 so as to be opposite to the sensor 210.

More specifically, the sensor 210 includes a mass body 211, a flexible beam 212, and a support 213.

According to an embodiment, the mass body 211, which is displaced by an inertial force, a Coriolis force, or an external force, as non-limiting examples, is displaceably connected to the flexible beam 212.

According to an embodiment, in order to implement an angular velocity sensor, the flexible beam 212 includes a driving electrode or driver and a sensing electrode or sensor formed on one surface thereof. In order to implement an acceleration sensor, the flexible beam 112 includes a piezoelectric resistance element formed on one surface thereof. In addition, the flexible beam 212, according to an embodiment, includes the mass body 211 coupled to the other surface thereof. The support 213 is coupled to the other surface of the flexible beam 212 so that the mass body 211 floats, and supports the flexible beam 212.

According to an embodiment, the upper cover 260 is coupled to the flexible beam 212 to cover the sensor 210.

Next, the ASIC 260, which controls the sensor 210 and calculates a physical amount including acceleration and angular velocity, is coupled to the upper cover 260 and is electrically connected to the sensor 210. According to at least one embodiment, the ASIC 260 is further electrically connected to the substrate 220 by the wire 270.

Additionally, the mold 280 is formed by packaging the sensoor 210 coupled to the substrate 220.

Additionally, the substrate 220 is electrically connected to the external board 230 by the conductive connector 240. According to an embodiment, the conductive connector 240 is made of a solder. According to another embodiment, the sensor 210 inputs and outputs information to and from the external board 230 through the substrate 230.

By the configurations described above, the MEMS sensor package module according to the various embodiments of the invention, is formed in a technical structure in which one side of the sensor 210 is coupled to the upper cover 250, the other side thereof is coupled to the substrate 220, and the upper cover 250 and the substrate 220 are provided with the cavities 251 and 221, respectively, such that the MEMS sensor package can be thinly formed, maximizing the driving performance by the optimal design of the depth of the cavity 251, 221 of the substrate 220.

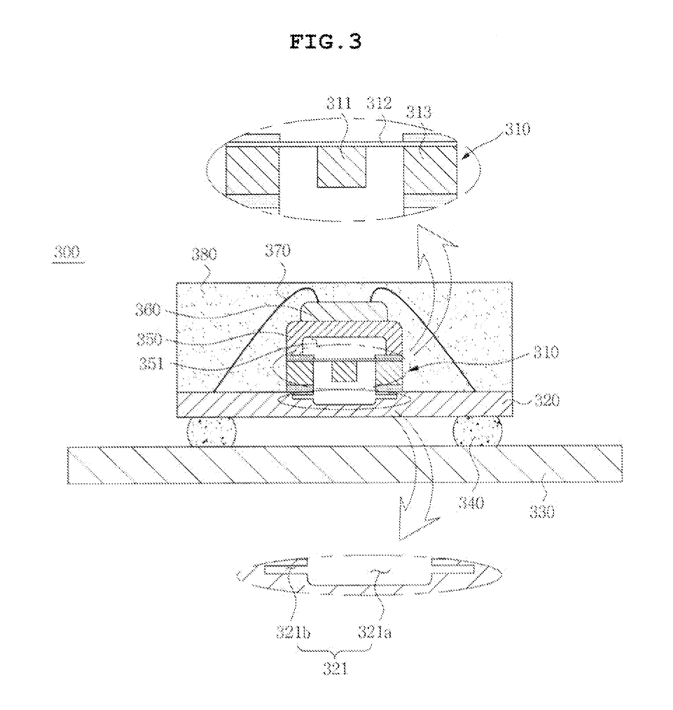

FIG. 3 is a cross-sectional view schematically showing a configuration of a MEMS sensor package module according to another embodiment of the invention. As shown in FIG. 3, the MEMS sensor package module, according to this embodiment, has a difference only in the cavity formed in the substrate as compared to the MEMS sensor package module according to the embodiment shown in FIG. 2. More specifically, the MEMS sensor package module 300, according to various embodiments, includes a sensor 310, a substrate 320, an external board 330, a conductive connector 340, an upper cover 350, an ASIC 360, a wire 370, and a mold 380. According to at least one embodiment, the substrate 320 is provided with a first cavity 321a in a stack direction in which the substrate 320 is coupled to the sensor 310 and a second cavity 321b extended to a direction perpendicular to the direction in which the first cavity 321a is formed.

More specifically, the sensor 310 includes a mass body 311, a flexible beam 312, and a support 313. As described above, the first cavity 321a is formed so as to be opposite to the mass body 311 in the stack direction in which the substrate 320 is coupled to the sensor 310, and the second cavity 321b is formed so as to be extended to the direction perpendicular to the direction in which the first cavity 321a is formed.

By forming the cavities 321a, 321b, as described above, the design for the depth of the cavity is possible by the first cavity 321a and the optimal design for the depth of the cavity is possible through the extending groove part of a width side by the second cavity 321b extended to the direction perpendicular to the direction in which the first cavity 321a is formed, thereby making it possible to improve the driving characteristics of the MEMS sensor.

Additionally, in technical configurations of the MEMS sensor package module according to this embodiment of the invention, as shown in FIG. 3, since the detail description of the technical configurations corresponding to those of the MEMS sensor package module according to the embodiment of the invention shown in FIG. 2 is described above, it will be omitted.

According to various embodiments of the invention, there is provided a thin MEMS sensor module, in which a separate sensor part cap is not coupled to a sensor part by forming a cavity in a substrate having the sensor part coupled thereto, maximizing driving performance by optimally designing a depth of the cavity in the substrate.

According to various embodiments of the invention, there is provided a MEMS sensor package module including a MEMS sensor having improved driving characteristics as a design for a depth of a cavity, in which a first cavity opposite to the sensor part and an optimal design for the depth of the cavity is possible through an extending groove part of a width side by a second cavity extended to a direction perpendicular to a direction in which the first cavity is formed.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A micro electro mechanical system (MEMS) sensor module, comprising:
a sensor;
a substrate connected to the sensor; and
an external board connected to the substrate by a conductive connector,
wherein the substrate is provided with a cavity so as to be opposite to the sensor.

2. The MEMS sensor module according to claim 1, wherein the sensor includes a mass body, a flexible substrate to which the mass body is displaceably coupled and on which a driver and a piezoelectric sensor are selectively formed, and a support having the flexible substrate coupled thereto and configured to support the mass body in a state in which it floats, and wherein the cavity of the substrate is formed so as to be opposite to the mass body.

3. A MEMS sensor package module, comprising:
a sensor;
an upper cover coupled to one side of the sensor;
a substrate coupled to the other side of the sensor;
an application specific integrated circuit (ASIC) coupled to the upper cover;
an external board connected to the substrate by a conductive connector; and
a mold configured to package the sensor coupled to the substrate,
wherein the substrate is provided with a cavity so as to be opposite to the sensor.

4. The MEMS sensor package according to claim 3, wherein the sensor includes a mass body, a flexible substrate to which the mass body is displaceably coupled and on which a driver and a piezoelectric sensor are selectively formed, and a support having the flexible substrate coupled thereto and configured to support the mass body in a state in which it floats, and wherein the cavity of the substrate is formed so as to be opposite to the mass body.

5. The MEMS sensor package module according to claim 3, wherein the cavity is formed to be extended to a stack direction in which the sensor is coupled to the substrate.

6. The MEMS sensor package module according to claim 3, wherein the ASIC is coupled to the substrate by wire bonding.

7. A MEMS sensor package module, comprising:
a sensor;
an upper cover coupled to one side of the sensor;
a substrate coupled to the other side of the sensor;
an ASIC coupled to the upper cover;
an external board connected to the substrate by a conductive connector; and
a mold configured to package the sensor coupled to the substrate,
wherein the substrate is provided with a first cavity in a stack direction in which the sensor is coupled to the substrate, and a second cavity extended in a direction perpendicular to a direction in which the first cavity is formed.

8. The MEMS sensor package module according to claim 7, wherein the sensor includes a mass body, a flexible substrate to which the mass body is displaceably coupled and on which a driver and a piezoelectric sensor are selectively formed, and a support having the flexible substrate coupled thereto and configured to support the mass body in a state in which it floats, wherein the first cavity of the substrate is formed so as to be opposite to the mass body, and wherein the second cavity thereof is extended to the direction perpendicular to the direction in which the first cavity is formed.

9. The MEMS sensor package module according to claim 7, wherein the ASIC is coupled to the substrate by wire bonding.

10. The MEMS sensor package module according to claim 7, wherein the conductive connector is a solder.
